(19) United States
(12) Patent Application Publication
(10) Pub. No.: US 2017/0088091 A1
(43) Pub. Date: Mar. 30, 2017

(54) DEPLOYABLE PEDESTRIAN SAFETY DEVICE FOR VEHICLES

(71) Applicant: Ford Global Technologies, LLC, Dearborn, MI (US)

(72) Inventors: David Maurice Ginn, Southend-on-Sea (GB); Thomas Ma, Chelmsford (GB)

(73) Assignee: Ford Global Technologies, LLC, Dearborn, MI (US)

(21) Appl. No.: 15/274,039

(22) Filed: Sep. 23, 2016

(30) Foreign Application Priority Data
Sep. 24, 2015 (GB) 1516896.6

(51) Int. Cl. B60R 21/34; B60R 19/56; B60T 7/22

(52) U.S. Cl. CPC B60R 21/34; B60T 7/22; B60R 19/56; B60R 2021/003

(57) ABSTRACT

A frontal structure for a motor vehicle includes a deployable air dam movable from a stowed position to one or more deployed positions., wherein the. The frontal structure is configured such that when a collision event is detected, predicted or anticipated, the deployable air dam is deployed into a first deployed position in which an edge of the deployable air dam forms the lowest point of the frontal structure and the edge also extends to a point of the frontal structure that is at least as far forward as any other part of the frontal structure of the vehicle in the same vertical plane.

### CROSS-REFERENCE TO RELATED APPLICATIONS

The subject application claims priority to and all the benefits of United Kingdom patent application 1516896.6 filed on Sep. 24, 2015, which is herein incorporated by reference in its entirety.

### TECHNICAL FIELD

This disclosure relates generally to devices in the field of improved vehicle safety, particularly the safety of pedestrians, and more particularly active safety systems.

### BACKGROUND

Modern day automotive vehicles are subject to rigorous, often legislative, demands to improve the safety not only of vehicle occupants but also persons outside of the vehicle itself, such as pedestrians. One of these requirements, at least in some jurisdictions, is that the lowermost section of the frontal bodywork of a vehicle is at least as far forward, in the longitudinal axis of the vehicle, as any other part or section of the bodywork (such as a bonnet/hood or other bumper part) higher up. The reason for this is that it is intended that the lowest part of the bumper should, in the event of an impact with a pedestrian, strike the pedestrian first or nearly first on the lower leg. This results in a rotation of the pedestrian's upper body around and on to the bonnet of the vehicle, which is in turn designed in modern vehicles to be provided at least with an air gap between the relatively soft sheet metal of the bonnet and any ‘hard’ powertrain elements beneath. In some embodiments the underside of the bonnet is provided with further cushioning means, which may include an active bonnet which lifts upon an impact to increase the air gap. This combined action of the foremost part of the bumper and the bonnet results in a reduction in likelihood of leg breakage and critical head injury. Were the lowermost part of the bumper or other bodywork of a vehicle to sit further back from a higher part of the bumper or bodywork, there would be a greater likelihood of a pedestrian's leg ‘catching’ underneath the front of the vehicle and being broken or otherwise damaged as a result, and a greater possibility of the pedestrian being caught underneath the higher bodywork, dragged down and ‘run over’.

The present disclosure is directed towards further improvements to the pedestrian safety of a vehicle, particularly a motor vehicle.

### SUMMARY OF THE DISCLOSURE

According to an aspect of the present disclosure, there is provided a frontal structure for a motor vehicle, the frontal structure comprising a deployable portion, such as an air dam, movable from a stowed position to one or more deployed positions. The frontal structure may be configured such that when a collision event, e.g. with a pedestrian, is detected, predicted or anticipated, said deployable air dam may be deployed into a first deployed position in which a lowest edge of the deployable air dam may form the lowest point of the frontal structure and a forward edge of the deployable air dam may form a point of the frontal structure that is at least as far forward as any other part of the frontal structure of the vehicle, e.g. in the same vertical plane. The vertical plane may contain a longitudinal direction of the vehicle.

The air dam may be used to block or limit air from moving under the vehicle, which may reduce aerodynamic lift effects, and their associated drag, when a vehicle is at speed. Handling benefits are also usually derived from air dam use, and, depending on the specifics of shape, the air dam may also be used to manage air flows into and/or around a vehicle for cooling/heat exchange in various other vehicle systems.

An advantage of the present disclosure is that the deployable air dam fulfils a further function of improving pedestrian safety in the event of a vehicle/pedestrian collision.

The collision event may be detected by a collision detection system. Those skilled in the art will be familiar with a number of variants of vehicle systems that are able to detect a collision so that certain vehicle items or systems may deploy or take other action in the event of a collision. Such collision detection systems are known in the art and comprise part of such systems as airbag deployment systems, active bonnets, and the like.

The collision event may be predicted by a collision prediction system. Those skilled in the art will also be familiar with systems that are able to predict a collision and allow other vehicle systems to take measures such as deployment or other action in the time immediately preceding a collision or potential collision—such as collision avoidance systems. Collision avoidance systems, also known as pre-crash systems, forward collision warning systems or collision mitigating systems, are known to use all-weather radar and sometimes laser and camera sensors (although both lasers and cameras may be affected by bad weather) to detect an imminent crash. Once the detection is done, these systems either provide a warning to the driver when there is an imminent collision or take action autonomously without any driver input (by braking or steering or both). Cars with Collision avoidance are often also equipped with adaptive cruise control (ACC) systems, and collision prediction systems will normally utilise many of the same sensors as ACC systems.

The collision event may be anticipated by a collision anticipation system. For example, the collision anticipation system may determine if a collision with a pedestrian is more likely at that particular time or in the particular area in which the vehicle is currently or is predicted to be. If the probability of a collision is calculated to be higher than a threshold value, then the air dam may be deployed to the first deployed position as a precaution. For example, the air dam may be deployed if the vehicle is in an urban area or approaching a school and/or at certain times.

The lowest edge of the deployable air dam, when deployed in the first deployed position, may form the lowermost point of any other frontal structure of the vehicle. The forward edge of the deployable air dam, when deployed in the first deployed position, may form the forwardmost point of any other frontal structure, or any other structure, of the vehicle, e.g. in the same vertical plane. The lowest and forward edges of the deployable air dam may be coincident or adjacent to one another.

The forward edge of the deployable air dam may be positioned when deployed in the first deployed position so as to be below the knee, e.g. knee pivot, of a pedestrian. For example, the forward edge of the deployable air dam may be positioned when deployed in the first deployed position so as to be lower than a knee pivot height of the Hybrid III 6 Year Old Child Dummy (i.e. 12.4 inches or 31.50 cm from the ground), the Hybrid III 5th percentile Female Crash Test Dummy (i.e. 16 inches or 40.64 cm from the ground) or any other knee pivot height as defined by the US National Highway Traffic Safety Administration and set out in the US Federal Motor Vehicle Safety Standards.

The deployable air dam may slide from the stowed position to the deployed positions, e.g. in a direction with a component in a forward direction and/or in a downwards direction. The frontal structure may comprise a sliding mechanism that permits the air dam, or at least a panel of the air dam, to slide relative to the remainder of the frontal structure.

The deployable air dam, e.g. a panel of the air dam, may rotate from the stowed position to the deployed positions. For example, the air dam may be connected to a hinge mechanism. The hinge mechanism may be such that a pivot point of the panel may be situated towards the front edge of the panel relative to its stowed position and stowage of the panel may be achieved by the panel swinging back and up relative to the forward motion of the vehicle.

The deployable air dam may comprise a movable member and a flexible membrane. The flexible membrane may be coupled to the movable member and adjacent portions of the frontal structure. For example, ends of the membrane may be coupled to the adjacent portions of the frontal structure and the movable member may be coupled to the membrane between said ends. Deployment of the deployable air dam may move the movable member and extend the flexible membrane from the vehicle with the movable member forming the lowest and/or forward edges. The movable member may comprise a bar about which the membrane may be wrapped. One end of the flexible membrane may be coiled about a roller. The flexible member may uncoil from the roller as the movable member is deployed. Additionally or alternatively, the flexible membrane may be elastic, e.g. the flexible membrane may stretch as it moves from the stowed position to the deployed positions or vice versa.

The deployable air dam may be repeatedly deployable and retractable. The frontal structure may comprise an actuator configured to move the deployable air dam between the stowed and deployed positions. The deployable air dam may be operatively coupled to a controller configured to control the deployment of the deployable air dam. The controller may send a signal to the actuator to deploy or retract the deployable air dam.

The deployable air dam may be flush with adjacent portions of the frontal structure in the stowed position so as to form a continuous surface. For example, when in the stowed position, an outer surface of a panel forming the air dam may be flush with and may constitute part of a substantially continuous (e.g. linear or curvilinear) outer surface of the front structure. Such a panel may be substantially planar (e.g. curved or flat) and the outer surface of the front structure may be provided with a shallow recess of substantially the same depth as the thickness of the panel, such that when the panel is deployed the front structure may retain a surface in the area from where the panel has just deployed, and when the panel is stowed it may fit snugly into the recess. The advantage of this is that items within the front structure remain protected from intrusion of dust and dirt and other items which may be thrown up from the road surface, whether the panel is stowed or deployed. Also when the panel is in its stowed position such that it is intended not to be vulnerable to damage from kerbs, speed bumps, etc, any external object which may nonetheless impact upon the stowed panel/front structure is less likely to damage the panel, because the panel is given support from the internal surface of the recess.

The deployable air dam and at least the adjacent portions of the frontal structure may be manufactured from a single piece. For example, the front structure, such as a bumper and an air dam panel, may be formed during manufacture initially together as a ‘one piece’ item from which the air dam panel may then subsequently be removed. The advantage here is that the substantially continuous surface—usually lower surface—of the front structure is readily achieved when, in subsequent use, the air dam panel is in its ‘retracted’ position and sitting flush with the surface of the front structure.

The deployable air dam may be configured to limit the flow of air beneath the vehicle in one or more of the deployed positions. The frontal structure may comprise one or more further deployable air dams. Such further air dams may be set back from the deployable air dam in a longitudinal direction of the vehicle.

The deployable air dam may be configured to be deployable to a second deployed position in which the air dam may be optimised for limiting the flow of air beneath the vehicle. In the second deployed position, the lowest edge may be higher and/or the forward edge may be further back than in the first deployed position. For example, the second position may be between the stowed position and the first deployed position.

The frontal structure may be operatively coupled to a braking system of the vehicle. The deployable air dam may be deployed to the first deployed position when brakes of the vehicle are applied. The braking system of the vehicle may be configured to automatically initiate a braking event to avoid a collision event, e.g. without driver input. The deployable air dam may be deployed to the first deployed position when brakes of the vehicle are automatically applied.

The best effects of an air dam may be derived when the lower edge of an air dam is close to the surface of a roadway. However, an air dam which is fixed in position with a lower edge close to the road surface is then vulnerable to impact damage with, for example, roadside kerbs or speed humps. Accordingly, the deployable air dam may default to the stowed position when the vehicle's speed is below a first threshold. For example, the air dam may be retracted at vehicle speeds below a certain threshold, e.g. 10 kph. At such low speeds it may be less essential for pedestrian protection and it may be more likely to encounter speed bumps etc. However, the air dam may nonetheless be deployed to the first deployed position if a collision is detected, predicted or anticipated.

The deployable air dam may be deployed to one of the deployed positions when the vehicle's speed exceeds the first threshold. For example, the deployable air dam may be deployed to the first deployed position when the vehicle's speed exceeds the first threshold. The deployable air dam may be deployed to, e.g. default to, the second deployed position when the vehicle's speed exceeds a second threshold. The second threshold may be equal to or higher than the first threshold. The air dam may nonetheless be deployed to the first deployed position if a collision is detected, predicted or anticipated.

Deploying the air dam when the vehicle is travelling at or at greater than a particular speed allows a greater amount of ground clearance than in a low-speed environment where, for example, speed humps may be present, with deployment of the air dam at a higher speed consistent with travel on generally higher-speed roads, such as motorways, where such obstacles will not normally be present. Further, it will be recognised by those skilled in the art that the aerodynamic improvement effected by an air dam will tend to be proportionally greater at higher speeds.

The deployable air dam may be retracted to the stowed position when a terrain sensing system determines that a greater ground clearance is desirable due to undulations in the terrain over which the vehicle is passing or is predicted to pass.

A frontal structure of the vehicle is any part of a vehicle that is situated, or at least partly situated, at the front section of such a vehicle. By way of example, this may be a bumper, grille, bonnet (hood), wing (fender or mudguard), cowling, front spoiler or air dam, or any other part of the vehicle front section. Accordingly, the frontal structure of the vehicle may comprise a bumper component, and the deployable portion may comprise the deployable air dam. It may be that the deployable air dam comprising the deployable portion comprises the entire, or nearly entire, initially externally visible portion of a bumper, with bumper support and/or sub-structures comprising the remainder of the frontal structure.

A vehicle may comprise the above-mentioned frontal structure.

To avoid unnecessary duplication of effort and repetition of text in the specification, certain features are described in relation to only one or several aspects or embodiments of the disclosure. However, it is to be understood that, where it is technically possible, features described in relation to any aspect or embodiment of the disclosure may also be used with any other aspect or embodiment of the disclosure.

### BRIEF DESCRIPTION OF THE DRAWINGS

For a better understanding of the present disclosure, and to show more clearly how it may be carried into effect, reference will now be made, by way of example, to the accompanying drawings, in which:

FIGS. 1a and 1b show schematic side views of a motor vehicle front according to a first arrangement of the present disclosure in stowed and deployed positions respectively;

FIGS. 2a and 2b show schematic side views of a motor vehicle front according to a second arrangement of the present disclosure in stowed and deployed positions respectively;

FIGS. 3a and 3b show schematic side views of a motor vehicle front according to a third arrangement of the present disclosure in stowed and deployed positions respectively; and

FIGS. 4a and 4b show schematic side views of a motor vehicle front according to a fourth arrangement of the present disclosure in stowed and deployed positions respectively.

### DETAILED DESCRIPTION

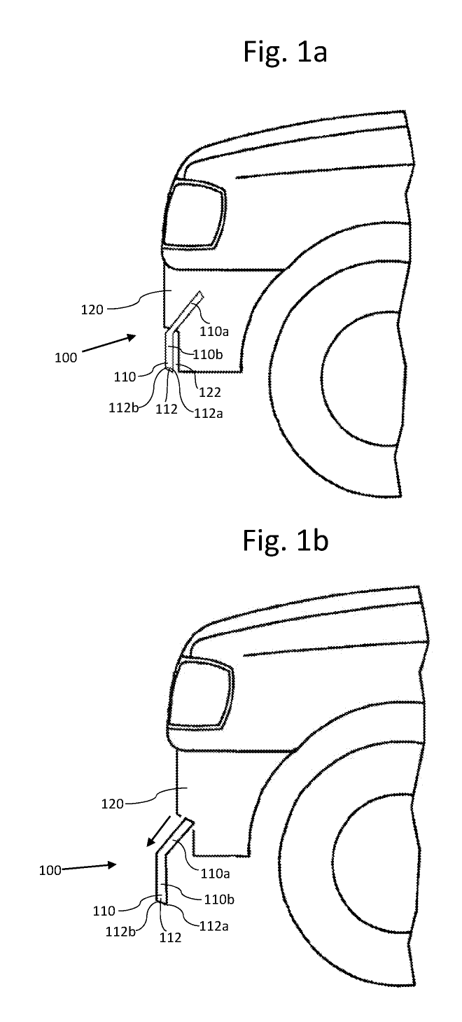

With reference to FIGS. 1a and 1b, a frontal structure 100 for a motor vehicle according to a first arrangement of the present disclosure comprises a deployable air dam 110. The deployable air dam 110 is movable from a stowed position, as depicted in FIG. 1a, to a deployed position, as depicted in FIG. 1b. The deployable air dam 110 comprises an end 112 comprising a first edge 112a, which when in the deployed position forms the lowest point of the frontal structure 100. The end 112 also comprises a second edge 112b that forms a point of the frontal structure 100 that is at least as far forward as any other part of the frontal structure in the same vertical plane. As depicted, the first and second edges 112a, 112b may be spaced apart, but in an alternative arrangement they may be coincident. The vertical plane may correspond to the sectional view depicted in the figures, which it will be appreciated contains a longitudinal direction of the vehicle.

As is depicted in Figures la and lb, the deployable air dam 110 may slide, e.g. linearly, relative to a support structure 120 forming part of the frontal structure 100. For example, the deployable air dam 110 may be provided in one or more grooves or slots within the support structure 120 so as to permit the deployable air dam to slide between stowed and deployed positions. In the particular arrangement shown in Figures la and lb, the deployable air dam slides in both a forwards and downwards direction as it moves from the stowed to the deployed position. Accordingly, the grooves or slots in the support structure 120 may be angled relative to a horizontal plane.

The deployable air dam 110 may comprise a first portion 110a that is angled relative to the horizontal plane. The first portion 110a may slide in the grooves or slots of the support structure 120. The deployable air dam 110 may comprise a second portion 110b, which is connected to the first portion 110a. As depicted, the second portion 110b may be substantially vertical, although it may be disposed at any other angle, e.g. substantially horizontal. The end 112 may be provided at the end of the second portion 110b. The support structure 120 may comprise a recess 122 configured to accommodate the second portion 110b of the deployable air dam 110 when in the stowed position. Accordingly, the deployable air dam 110 may be substantially flush with the surrounding support structure 120 when in the stowed position. The second portion 110b may be omitted and the end 112 may be provided on the first portion 110a.

An actuator (not shown) may be provided to move the deployable air dam 110 between the stowed and deployed positions. The actuator may be in the form of a linear actuator, such as a pneumatic or hydraulic ram, or any other actuator, such as a motor and gear assembly.

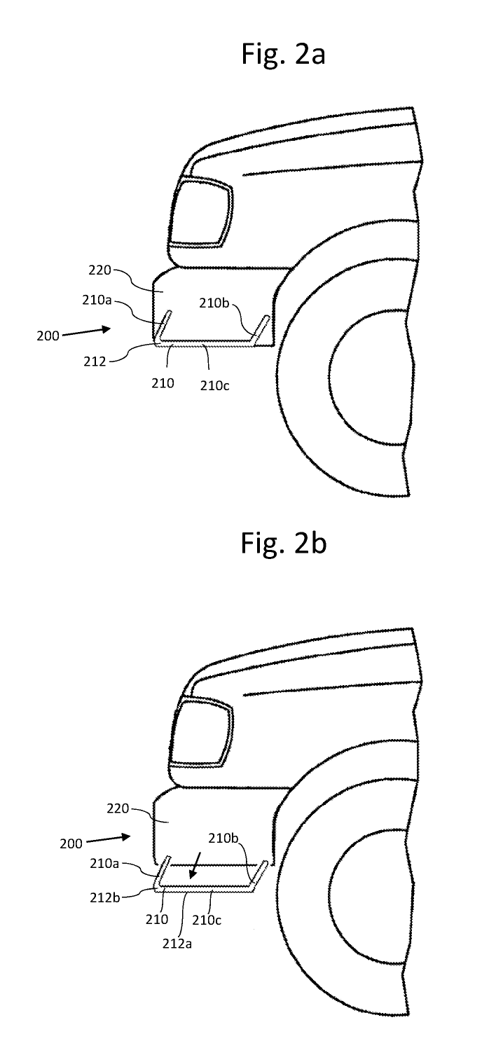

With reference to FIGS. 2a and 2b a frontal structure 200 according to a second arrangement of the present disclosure is shown. The frontal structure 200 comprises a deployable air dam 210, which slides from a stowed position, depicted in FIG. 2a, to a deployed position, depicted in FIG. 2b. The second arrangement is thus similar to the first arrangement described above. In particular, the deployable air dam 210 of the second arrangement may slide in both a forwards and downwards direction as it moves from the stowed position to the deployed position.

A first edge 212a of the deployable air dam 210 forms the lowest point of the frontal structure 200 when deployed. A second edge 212b of the deployable air dam 210 also forms a point that is at least as far forward as any other part of the frontal structure 200 in the same vertical plane. The first and second edges 212a, 212b may be spaced apart or they may be coincident.

The deployable air dam 210 comprises first and second sliding portions 210a, 210b. The second sliding portion 210b is set back from the first sliding portion 210a in the longitudinal direction. Both the first and second sliding portions 210a, 210b are angled relative to the horizontal plane. The first and second sliding portions 210a, 210b may be inclined relative to the horizontal plane by the same angle. The first and second sliding portions 210a, 210b slide relative to a support structure 220, which may comprise grooves or slots for receiving the first and second sliding portions 210a, 210b.

The first and second sliding portions 210a, 210b may be joined together by a connecting portion 210c. The connecting portion 210c may form the first edge 212a. The second edge 212b may be formed at the interface between the first sliding portion 210a and the connecting portion 210c. Alternatively, the first and second edges 212a, 212b may be provided at a point that extends beyond where the first sliding portion 210a and connecting portion 210c meet.

As for the first arrangement, an actuator (not shown) may be provided to move the deployable air dam 210 between the stowed and deployed positions. The actuator may comprise any type of actuator, e.g. those described above, that is capable of sliding the deployable air dam between the stowed and deployed positions.

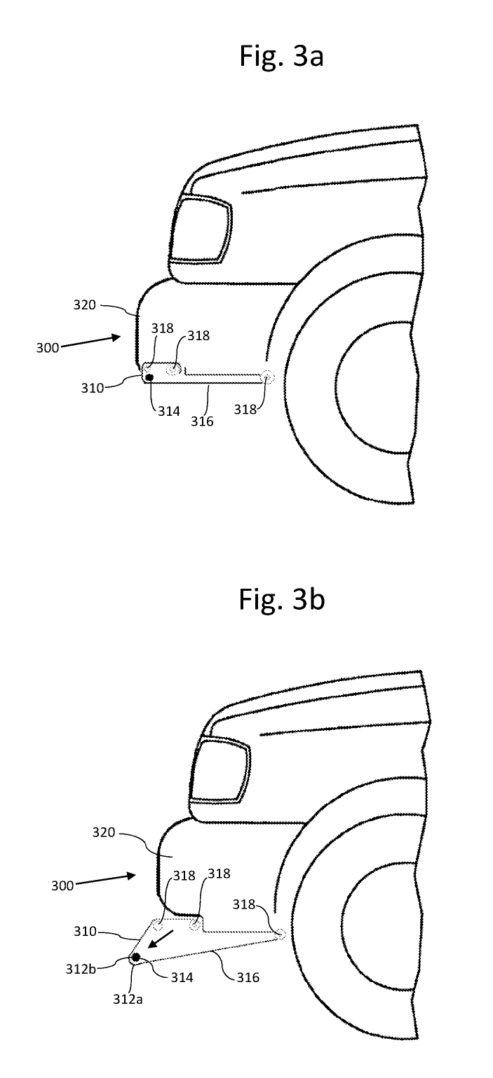

With reference to FIGS. 3a and 3b a frontal structure 300 according to a third arrangement of the present disclosure is shown. The frontal structure 300 comprises a deployable air dam 310 which is configured to move from a stowed position, as depicted in FIG. 3a to a deployed position as depicted in FIG. 3b. The deployable air dam 310 comprises a movable member 314 that moves between the stowed and deployed positions. A flexible member 316, which may be in the form of a membrane, may extend around the movable member 314. As the movable member 314 moves between the stowed and deployed positions, the flexible member 316 may stretch or unfurl. The flexible member 316 may be coupled to a support structure 320 of the frontal structure 300.

The movable member 314 may be in the form of a roller about which the flexible member 316 may be at least partially wrapped. The flexible member 316 may be coupled to one or more additional rollers 318, which are provided on the support structure 320. The flexible member 316 may unwrap or stretch from the rollers 318.

As mentioned above, the movable member 314 may move in a forwards and downwards direction as it is deployed. Although not shown, an actuator, like those described above, may be provided to move the movable member 314 between the stowed and deployed positions. A further mechanism may be provided between the movable member 314 and the actuator.

The movable member 314 and the adjacent portion of the flexible member 316 may together form a first edge 312a that is the lowest point of the frontal structure in the deployed position and a second edge 312b that is at least as far forward as any other part of the frontal structure in the same vertical plane when deployed.

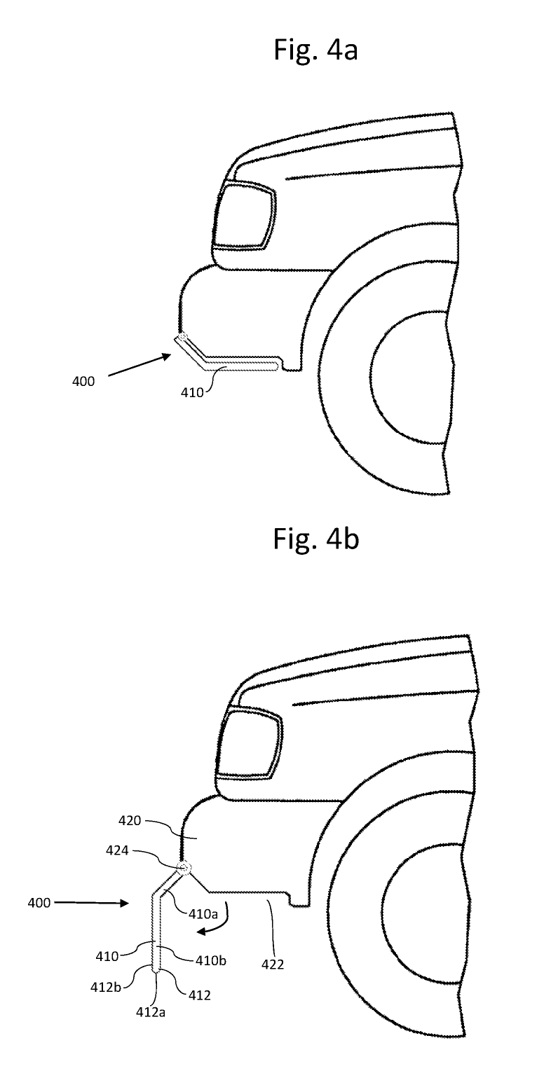

With reference to FIGS. 4a and 4b, a frontal structure 400 according to a fourth arrangement of the present disclosure comprises a deployable air dam 410. The deployable air dam 410 moves from a stowed position, as depicted in FIG. 4a, to a deployed position, as depicted in FIG. 4b. In the deployed position the deployable air dam 410 comprises an end 412 comprising a first edge 412a, which forms the lowest point of the frontal structure 400. The end 412 also comprises a second edge 412b of the frontal structure 400 that is at least as far forward as any other part of the frontal structure 400 in the same vertical plane when deployed. The first and second edges 412a, 412b may be spaced apart or they may be coincident.

The deployable air dam 410 may rotate between the stowed and deployed positions. In the particular arrangement shown, the deployable air dam 410 may rotate about a pivot point 424 provided on a support structure 420 of the frontal structure 400. In alternative arrangements the deployable air dam 410 may not rotate about a fixed pivot point like that shown in FIGS. 4a and 4b, for example the deployable air dam may be connected to the support structure by virtue of a four bar chain mechanism. In the particular arrangement shown, the pivot point 424 may be provided towards the front of the frontal structure 400.

The deployable air dam 410 may comprise first and second portions 410a, 410b. The first portion 410a may be coupled to the pivot point 424. In the deployed position the first portion 410a may extend in a direction with a forward component. In the particular arrangement shown, the first portion 410a also extends in a downwards direction in the deployed position.

The second portion 410b is coupled to the first portion 410a. In the particular arrangement shown the second portion 410b may be substantially vertical in the deployed position. The edges 412a, 412b may be provided at an end of the second portion 410b that is furthest from the first portion 410a, although the second edge 412b may be provided where the first and second portions 410a, 410b meet.

The support structure 420 may comprise a recess 422. The recess 422 may accommodate the deployable air dam 410 in the stowed position such that the deployable air dam is substantially flush with the surrounding support structure 420.

As mentioned above, an actuator (not shown) may be provided to move the deployable air dam between the stowed and deployed positions. The actuator may be of any type, e.g. as those described above, which is capable of rotating the deployable air dam between the stowed and deployed positions.

With any of the above-mentioned arrangements, the second edges 112b, 212b, 312b, 412b may be positioned so as to be below the knee of a pedestrian. In particular, the edge may be at a height above the ground that is lower than a knee pivot height of the Hybrid III 6 Year Old Child Dummy (i.e. 12.4″ or 31.5 cm from the ground), the Hybrid III 5^{th} Percentile Female

Crash Test Dummy (i.e. 16″ or 40.64 cm from the ground) or any other knee pivot height as defined by the US National Highway Traffic Safety Administration and set out in the US Federal Motor Vehicle Safety Standards. By providing the second edge at or below such a height, the likelihood of a pedestrian's leg being swept underneath the frontal structure is reduced. Instead, in the event of a collision the pedestrian is more likely to be swept onto the bonnet of the vehicle where other safety measures may reduce the injuries sustained by the pedestrian.

Furthermore, in each of the above described arrangements the deployable air dam 110, 210, 310, 410 may reduce aerodynamic lift effects when in the deployed position by reducing the flow of air beneath the vehicle. Accordingly, the deployable air dam may be deployed when the vehicle exceeds a threshold speed at which such aerodynamic affects become significant. When the deployable air dam is to limit the flow of air beneath the vehicle the deployable air dam may be deployed to the fully deployed position or an intermediate position, e.g. in which the edge 112b, 212b, 312b, 412b is not as far forward as those depicted.

A controller (not shown) configured to control the deployment of the deployable air dam 110, 210, 310, 410 may be provided. The controller may send a signal to the actuator to deploy or retract the deployable air dam.

The controller may be operatively coupled to a braking system of the vehicle. The controller may instruct the actuator to deploy the deployable air dam when brakes of the vehicle are applied. The braking system of the vehicle may be configured to automatically initiate a braking event to avoid a collision event, e.g. without driver input.

If a collision event with a pedestrian is detected, predicted or anticipated, the deployable air dam 110, 210, 310, 410 is deployed into the deployed position. For example, the controller may be coupled to a collision detection system (not shown). The collision detection system may detect if a collision e.g. with a pedestrian, is occurring. The controller may then deploy the deployable air dam.

Additionally or alternatively, the controller may be operatively coupled to a collision anticipation system (not shown). The collision anticipation system may determine if a collision, e.g. with a pedestrian, is more likely at that particular time or location.

If the probability of a collision is calculated to be higher than a threshold value, then the controller may instruct the actuator to deploy the air dam as a precaution. For example, the air dam may be deployed if the vehicle is in an urban area or approaching a school and/or at certain times.

Additionally or alternatively, the controller may be operatively coupled to a collision prediction system (not shown). The collision prediction system may predict if a collision, e.g. with a pedestrian, is about to occur. If the collision prediction system determines that the probability of a collision occurring is above a certain threshold, the controller may send a signal to the actuator to deploy the air dam.

The controller may instruct the actuator to retract the deployable air dam when the speed of the vehicle is below a certain threshold. At low speeds the vehicle may be more likely to encounter undulations in the terrain which require greater ground clearance. Additionally or alternatively, the controller may be operatively coupled to a terrain sensing system that monitors the terrain over which the vehicle is passing or is about to pass. If the terrain sensing system determines that a greater ground clearance is desirable due to undulations in the terrain, the controller may instruct the actuator to retract the deployable air dam to the stowed position.

The controller may automatically deploy the deployable air dam to the deployed position when the vehicle speed exceeds a first threshold. The controller may be further configured to deploy the deployable air dam to the intermediate position mentioned above when the vehicle speed exceeds a second threshold higher than the first threshold. The intermediate position of the deployable air dam may be optimized for aerodynamic benefits at higher speeds and may thus be more appropriate at speeds exceeding the second threshold. Although pedestrian collisions are less likely at higher speeds, e.g. on motorways, the controller may nonetheless deploy the deployable air dam to the deployed position if a collision event is detected, predicted or anticipated.

The above mentioned deployable air dams 110, 210, 310, 410 and the surrounding support structure 120, 220, 320, 420 may be manufactured from a single piece. During manufacture the air dam or at least a portion of the air dam may be separated from the support structure so that the air dam may be movable relative to the support structure. Advantageously, the deployable air dam may then follow the contours of the surrounding structure when in the stowed position and the air dam may be flush with the surrounding structure.

It will be appreciated by those skilled in the art that although the disclosure has been described by way of example, with reference to one or more examples, it is not limited to the disclosed examples and alternative examples may be constructed without departing from the scope of the disclosure as defined by the appended claims.

1. A frontal structure for a motor vehicle, the frontal structure comprising:
a deployable air dam movable from a stowed position to one or more deployed positions;
wherein the deployable air dam is deployable relative to the rest of the frontal structure into a first deployed position when a collision event is detected, predicted or anticipated;
wherein in the first deployed position, a lowest edge of the deployable air dam forms the lowest point of the frontal structure and a vehicle-forward edge of the deployable air dam forms a point of the frontal structure that is at least as far forward in a vehicle forward direction as any other part of the frontal structure of the vehicle in the same vertical plane.

2. The frontal structure of claim 1, wherein the lowest edge of the deployable air dam, when deployed in the first deployed position, forms the lowermost point of any other frontal structure of the vehicle.

3. The frontal structure of claim 1, wherein the vehicle-forward edge of the deployable air dam, when deployed in the first deployed position, forms the forwardmost point of any structure of the vehicle.

4. The frontal structure of claim 1, wherein the vehicle-forward edge of the deployable air dam is positioned when deployed in the first deployed position so as to be below the knee pivot of a pedestrian.

5. The frontal structure of claim 1, further comprising a support structure, wherein the deployable air dam slides relative to the support structure from the stowed position to the deployed positions.

6. The frontal structure of claim 5, wherein the deployable air dam slides relative to the support structure in a direction, the direction having a component in a vehicle-forward direction.

7. The frontal structure of claim 5, wherein the deployable air dam slides relative to the support structure in a direction, the direction having a component in a downwards direction.

8. The frontal structure of claim 1, further comprising a support structure and a pivot point between the deployable air dam and the support structure, wherein the deployable air dam rotates about the pivot point from the stowed position to the deployed positions.

9. The frontal structure of claim 1, further comprising a movable member and a flexible membrane, the flexible membrane being coupled to the movable member and adjacent portions of the frontal structure, wherein deployment of the deployable air dam to the first deployed position moves the movable member and extends the flexible membrane from the vehicle with the movable member forming the lowest edge and the vehicle-forward edge.

10. (canceled)

11. The frontal structure of further comprising an actuator configured to move the deployable air dam between the stowed and deployed positions.

12. The frontal structure of claim 1, wherein the deployable air dam is flush with adjacent portions of the frontal structure in the stowed position so as to form a continuous surface.

13. The frontal structure of claim 12, wherein the deployable air dam and at least the adjacent portions of the frontal structure are manufactured from a single piece.

14. The frontal structure of claim 1 further comprising one or more further deployable air dams in a vehicle-rearward direction from the deployable air dam in a longitudinal direction of the vehicle.

15. The frontal structure of claim 1, wherein the deployable air dam is configured to limit the flow of air beneath the vehicle in one or more of the deployed positions.

16. The frontal structure of claim 1, wherein the deployable air dam is configured to be deployable to a second deployed position in which the air dam reduces the flow of air beneath the vehicle relative to the flow of air beneath the vehicle when the air dam is in the first deployed position.

17. The frontal structure of claim 16, wherein in the second deployed position the lowest edge is higher and/or the forward edge is further back in a vehicle-rearward direction than in the first deployed position.

18. The frontal structure of claim 1, wherein the frontal structure is designed to be operatively coupled to a braking system of the vehicle such that the deployable air dam is deployed to the first deployed position when brakes of the vehicle are applied.

19. The frontal structure of claim 1, wherein the frontal structure is designed to be operatively coupled to a braking system of the vehicle configured to automatically initiate a braking event to avoid a collision event, and wherein the deployable air dam is deployed to the first deployed position when brakes of the vehicle are automatically applied.

20-25. (canceled)

26. The frontal structure of claim 1, wherein the deployable air dam is designed to be operatively coupled to a controller configured to control the deployment of the deployable air dam.

27. (canceled)

28. (canceled)
